(19) United States
(12) Patent Application Publication
(10) Pub. No.: US 2007/0274240 A1
(43) Pub. Date: Nov. 29, 2007

(54) Upnp Terminal for Ad Hoc Wireless Networks

(76) Inventors: Klaus Weidenhaupt, Aachen (DE); David Sanchez Sanchez, Aachen (DE); Thomas Falck, Aachen (DE); Henning Maass, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/558,083

(22) PCT Filed: Mar. 14, 2004
(86) PCT No.: PCT/IB04/50701

§ 371 Date: Sep. 18, 2006

(30) Foreign Application Priority Data
May 28, 2003 (EP) 03101563.9

(51) Int. Cl. H04L 12/28; H04B 7/00; H04L 29/06

(52) U.S. Cl. 370/310

(57) ABSTRACT

The invention relates to a wireless network comprising at least two terminals which each contain a UPnP (Universal Plug and Play) software component and a UPnP controller software component. According to the invention, the UPnP controller software component of a terminal forwards specific messages from the associated UPnP software component to subordinate software components only following a change in the network topology.

The invention relates to a wireless network comprising at least two terminals which each contain a UPnP (Universal Plug and Play) software component.

The architecture of a wireless UPnP (Universal Plug and Play) for an ad-hoc network is described in the document “World News, Philips Semiconductors, MultiMarket Semiconductors Focus, Volume 12, Number 1, January-February 2003, page 2”. This network uses Bluetooth technology and the UPnP protocol to set up communication with terminals for example over short distances. In order to discover terminals wishing to integrate into an existing network, a software component (Dynamic Personal Area Network Manager) has been provided which forwards messages to the respective UPnP module. A terminal that is to be newly integrated starts a so-called discovery phase in order to discover other terminals. The terminals which are already in the network are quiet until they receive a message during the discovery phase from the terminal that is to be integrated. No further details are given as to how the connection setup and the data exchange between the various software components is carried out in such a network.

It is an object of the invention to provide a network which links the UPnP software component of a terminal in a suitable manner to subordinate software components.

The object is achieved by a network of the type mentioned above by means of the following measures:

The wireless network has at least two terminals which each contain a UPnP (Universal Plug and Play) software component and a UPnP controller software component, wherein the UPnP controller software component of a terminal is provided to enable specific messages from the associated UPnP software component to subordinate software components only following a change in the network topology.

The wireless network according to the invention may be operated for example in accordance with the Bluetooth standard or the standard “Wireless IEEE 802.11 (Wireless LAN)”. Besides the UPnP controller software component, a terminal also contains other software components, namely network software and software for detecting changes in the network topology and for generating signals for the UPnP controller software component in the event of changes in the network topology. The UPnP controller software component configures the UPnP software component such that no unnecessary messages reach the subordinate software components and hence a terminal or the network is not unnecessarily loaded with messages.

In this case, the UPnP controller software component of a terminal is provided to block messages from the associated UPnP software component prior to the setting up of a connection to the network or to block messages from the associated UPnP software component prior to the setting up of a connection of another terminal in the network.

During network setup, the case must be distinguished where only two terminals have set up a connection or at least a third terminal is integrated. In the first case, the UPnP controller software component of a terminal transmits, after a connection has been set up to the only other terminal of the network, a search message relating to a specific service or a message about the availability of a specific service only if its own address meets a predefined criterion. During the discovery phase, a newly integrated terminal transmits, as server, a service message from the associated UPnP software component and, as client, a service search message to other terminals. The UPnP controller software component controls these messages from the UPnP software component. By way of example, a terminal operating as a printer may offer its printing service, or a text processing program in a terminal searches for a specific printing service.

In the case of two terminals which form a new network, it is provided according to the invention that a terminal transmits a service message or a service search message only if its address meets a defined criterion. This criterion may for example be the lower address of the two newly integrated terminals.

In the second case, when a terminal is integrated in a network as third, fourth, etc. terminal, said terminal then transmits, in a manner controlled by the associated UPnP controller software component, a search message relating to a specific service or a message about the availability of a specific service and hence starts the discovery phase.

If after a defined time following the setting up of a connection to another terminal a terminal has not received its search message relating to a specific service or its message about the availability of a specific service, it then transmits its own search message relating to a specific service or its own message about the availability of a specific service.

The UPnP controller software component receives a Connected signal when the associated terminal is integrated, a Join Alert signal when another terminal is integrated, a Disconnected signal when the associated terminal leaves the network and a Leave Alert signal when another terminal leaves, these signals being received from a DPM software component which serves to detect changes in the network topology.

The UPnP controller software component of a terminal deletes all information relating to another terminal after the other terminal has left the network, and the UPnP controller software component of the terminal which has left the network deletes all information about the terminals still in the network.

The invention also relates to a terminal in a wireless network comprising at least one other terminal, wherein the terminal contains a UPnP software component and a UPnP controller software component.

The invention will be further described with reference to examples of embodiments shown in the drawings to which, however, the invention is not restricted.

FIG. 1 shows a highly simplified layer model of the software components contained in a terminal.

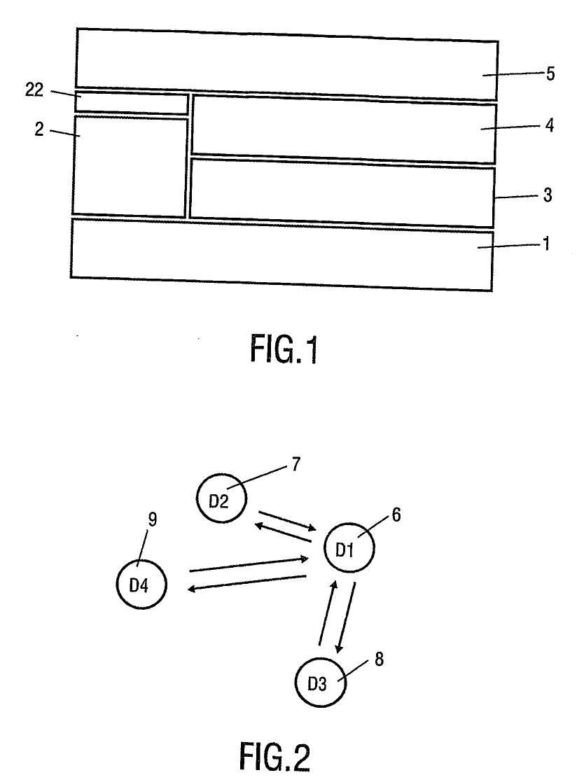

FIG. 2 shows a network comprising various terminals.

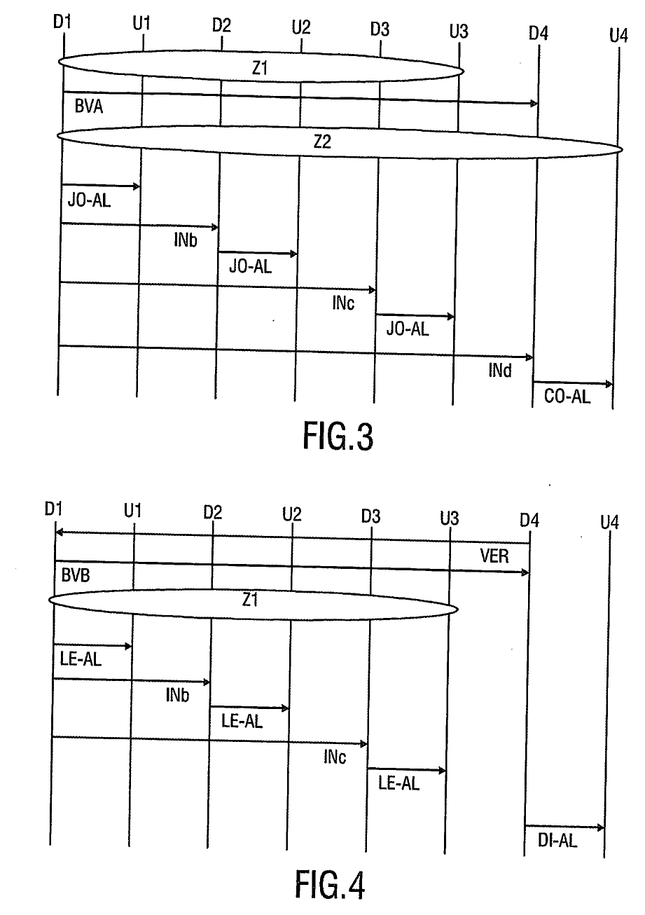

FIGS. 3 to 7 show various signal sequences in the network shown in FIG. 2.

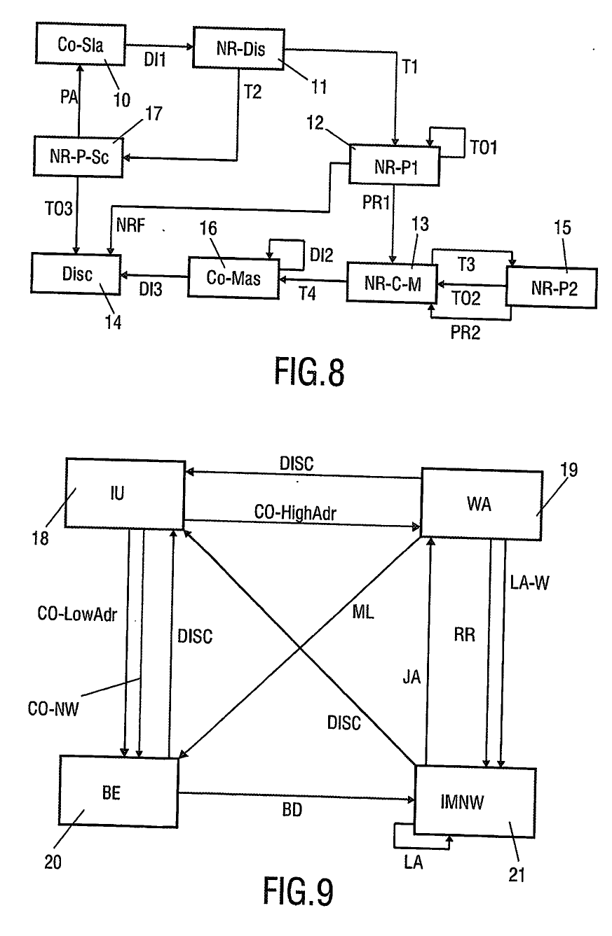

FIGS. 8 and 9 show state diagrams of software components, according to the invention, of a terminal.

In order to form an ad-hoc network, use is made of the UPnP standard (UPnP=Universal Plug and Play) which is described for example in “IEEE Communications Magazine, December 2001, Vol. 39, No. 12”. An ad-hoc network is an unconfigured network which new terminals can spontaneously enter into or spontaneously leave again without manual intervention. Examples of such ad-hoc networks are a conference scenario or a scenario in which people with the same interests who have mobile devices can meet with one another and offer each other files to download (music files).

The UPnP standard relates to a server-client structure. A terminal that is integrated as server in a UPnP network offers services and a terminal that is integrated or is to be integrated as client uses or searches for specific services. For this purpose, the UPnP standard has five different phases. The first phase (discovery phase) relates to the discovery of the presence of other terminals, the second phase (description phase) relates to being informed about the capabilities of the other terminals and the third to fifth phases (control phase, eventing phase and presentation phase) relate to the transmission of information between the terminals. For each of these phases, the UPnP standard defines a number of protocols which are based on the Internet protocol.

During the discovery phase, a terminal which has up to now not been integrated in a network finds other terminals located in the network. As protocol in the discovery phase, the UPnP standard uses a Simple Service Discovery Protocol (SSDP), to which reference is also made in the document “IEEE Communications Magazine, December 2001, Vol. 39, No. 12”. A terminal that is integrated as server periodically transmits service messages via a multicast connection, in which messages it provides its own address and offers its service. Alternatively, it is also possible that a terminal integrated as client transmits service search messages via a multicast connection. If a terminal offers the service that is sought, it transmits a response to the searching terminal via a unicast connection. In order not to inundate the network with too many messages in the discovery phase, it is recommended in the UPnP standard, which was actually developed for wired networks, that the period of the service or search messages be about 1800 s long.

The situation is different in the case of a wireless network. In this case, connections often exist only for a few seconds. For example, in a network set up in accordance with the Bluetooth standard, this connection exists for two people passing one another at walking speed, about 10 s. Furthermore, the available bandwidth in a wireless network is limited compared to a wired network. Moreover, in a wireless network which uses the UPnP standard, data packets are often lost on account of radio interference.

In order nevertheless to make the UPnP standard available in a wireless network, a terminal contains a software component known as a “Dynamic Personal Area Network Manager” (hereinafter referred to as DPM software) which cooperates with network software, UPnP software and application software and is provided to set up and control an ad-hoc network. A highly simplified layer model of the software components is shown in FIG. 1. Above the layer 1, which represents the network software, there is arranged the layer comprising the DPM software 2, IP software 3 provided for the Internet protocol and the UPnP software 4. The UPnP controller software 22 is located above the DPM software 2. The UPnP controller software 22 is informed about changes in the network topology by the DPM software 2 and on the basis of this information controls the response of the UPnP software 4. The application software 5 is located in the uppermost layer.

The DPM software 2 detects changes in the network topology, exchanges various information with the UPnP controller software 22 and delivers four types of command to the UPnP controller software 22. When a terminal wishes to integrate into a network, the DPM software 2 transmits a first signal, referred to as the Connected signal, to the UPnP controller software 22. The DPM software 2 of a terminal that is already integrated in the network transmits a signal, referred to as the Join Alert signal, to its UPnP controller software 22 when another terminal has become a member of the network. The UPnP controller software 22 of a terminal receives a third signal, referred to as the Disconnected signal, from the associated DPM software 2 when said terminal has left the network. Accordingly, the UPnP controller software 22 of a terminal receives a fourth signal, referred to as the Leave Alert signal, from its DPM software 2 when it remains in the network but another terminal leaves the network.

The network software 1 is located in the lowermost layer (physical layer) of the software. By means of this software component, a network can be set up in accordance with a network standard. One example of this is the Bluetooth or network standard IEEE 1394. The DPM software 2 ascertains whether the network topology has changed by detecting certain signals from the network software 1, or is informed about changes in the network topology by the DPM software of other terminals.

Bluetooth is a communications standard for wireless radio communications, which is said to allow data exchange between all conceivable types of terminal. Regardless of whether these be notebooks, organizers, mobile telephones or computer peripherals, Bluetooth is said to give all terminals the capability of being able to communicate with one another. The terminals in a Bluetooth network operate on 79 channels with in each case 1 MHz bandwidth in the 2.45 GHz frequency range. During communication, the same channel is not used continuously but rather the frequency is changed 1600 times per second (frequency hopping) in order to compensate for interference from other devices. This is necessary since the frequency band used is freely available. The useful data are transported in a packet-oriented manner and various packet types are defined in order to meet the application requirements. These packet types differ according to synchronous and asynchronous operation and are identified by an entry in the header of the data packet.

Essential features of a Bluetooth device are firstly a dedicated clock which defines the clock rate in the event of the frequency jumps, and also a unique Bluetooth terminal address (Bluetooth device address). From this there is then also obtained the identity of the terminal, which defines the various frequencies of the hopping sequence.

Upon connection of two Bluetooth terminals, one assumes the role of master terminal and the other the role of slave terminal. It should be noted that there is no prior determination of master or slave terminal; the distribution of the roles takes place dynamically upon setup of the connection. The master terminal compulsorily defines the hopping sequence for the slave terminal, that is to say the “jumps” between the frequencies, and distributes transmission rights.

There are two phases during setup of a connection. The first phase is referred to as the Inquiry phase and is used when a search is to be made for as yet undiscovered terminals about which there is no information. As long as there is no connection, a terminal continually swaps between the Inquiry and Inquiry Scan states. In the Inquiry state, the terminal jumps between 32 frequencies and sends out its inquiry. In the Inquiry Scan state, the device likewise jumps between 32 frequencies and searches for an Inquiry message. If a terminal receives such an inquiry in the Inquiry Scan state, it responds by transmitting its address and clock and a communication can begin.

The second phase of the connection setup is referred to as the Page phase. In this phase, one terminal changes into the Page state and the other terminal changes into the Page Scan state. The distribution of the roles is defined such that the inquiring terminal becomes the master terminal and the other becomes a slave terminal. One condition is that the Bluetooth terminal address of the slave terminal is known to the master terminal. The Page phase can be speeded up if, besides the address, the clock of the slave terminal is also known to the master terminal. The master terminal transmits its own clock and hopping sequence to the slave terminal and instructs the latter to take over the latter. The slave terminal then synchronizes with the master terminal and can thus communicate with the latter.

Between the individual terminals, data packets are transmitted which contain, besides the useful data, also additional information such as transmitter and receiver address, transmission options, synchronization and possibly security information, and additional redundancies. Such a packet consists of a 72 bit access code, a 54 bit header and a variable useful data field having a length of 0 to 2745 bits. For the Inquiry phase, use is made for example of an ID packet which contains the address of the terminal. Another packet is the FHS packet (FHS=Frequency Hopping Synchronization), by means of which inter alia clock information, the terminal address, the phase of the hopping sequence and the “class of service” designation (which type of device in the network is concerned) are transmitted during connection setup.

Bluetooth networks may be implemented in a point-to-point, piconetwork or scatter network topology. These network topologies open up a large number of conceivable application possibilities. A piconetwork consists of a master terminal and up to seven active slave terminals. A master may in principle control more than seven slave terminals by sending some slave terminals into a kind of sleep mode. However, this may considerably slow down the data exchange, especially if an active slave terminal wishes to transmit data to another slave terminal in a sleep mode. In this case, communication fundamentally passes exclusively via the master terminal, which distributes transmission rights and defines the frequencies that are to be used. The master terminal distributes transmission rights to the individual slave terminals in an alternating manner.

The integration of a terminal and the planned or unplanned leaving of a terminal in the network (piconetwork) will be explained in more detail below with reference to FIGS. 2 to 7. First, the case where a terminal 9 wishes to be integrated as slave terminal into an existing terminal comprising the slave terminals 7 and 8 and the master terminal 6 is considered. The master terminal 6 contains DPM software D1 and UPnP controller software U1, the slave terminal 7 contains DPM software D2 and UPnP controller software U2, the slave terminal 8 contains DPM software D3 and UPnP controller software U3 and the slave terminal 9 contains DPM software D4 and UPnP controller software U4. At given time intervals, the master terminal 6 informs all slave terminals 7 and 8 about the current network topology. Following detection and integration of the terminal 9, the master terminal transmits messages about the newly integrated slave terminal 9 to all other slave terminals 7 and 8. In these messages, the master terminal 6 informs them for example about the address of the slave terminal 9. The slave terminal 9, on the other hand, receives from the master terminal 6 the addresses of the other terminals. It is thereby ensured that all terminals always have an overview of the current network topology.

Following integration into the network, the DPM software D4 of the newly integrated terminal 9 transmits a Connected signal to its UPnP software U4. The DPM software D2, D3 and D4 of the other terminals 6 to 8 in each case transmit a Join Alert signal to their respective UPnP software U2, U3 and U4. The terminals 6 to 8 thus know that a new slave terminal has been integrated into the network. The Discovery phase is initiated in a terminal each time a Connected or Join Alert signal is received.

The various states and signals which occur between the respective DPM software D1 to D4 and the respective UPnP controller software U1 to U4 during integration of the terminal 9 are shown in FIG. 3. The state Z1 in FIG. 3 refers to the piconetwork comprising the master terminal 6 and the slave terminals 7 and 8. The signal BVA from the DPM software D1 to the DPM software D4 means that a connection is to be set up between the terminals 6 and 9. After the connection has been set up, a piconetwork exists which comprises the master terminal 6 and the slave terminals 7, 8 and 9 (state Z2). By means of the signals INb and INc, the DPM software D1 informs the respective DPM software D2 and D3 about the new terminal 9. The respective DPM software D1, D2 and D3 then in turn transmits in each case a Join Alert signal JO-AL to the respective UPnP controller software U1, U2 and U3. The DPM software D1 also informs the DPM software D4 about the other terminals of the piconetwork by means of the signal INd, and the UPnP controller software U4 is informed by its dedicated DPM software D4 about the connection setup by means of the Connected Alert signal CO-AL.

Hereinbelow, a total of four different situations will be considered in which at least one terminal leaves the network in a planned or unplanned manner. In the first case, a slave terminal (e.g. terminal 9) tells the master terminal 6 that it is leaving. FIG. 4 shows the corresponding signal sequence relating to this. By means of its DPM software D4, the slave terminal 9 informs the DPM software D1 of the master terminal 6, via the signal VER, that it wishes to leave the network. Via the signal BVB, which is exchanged between the DPM software D1 and the DPM software D4, the master terminal 6 terminates the connection to the slave terminal 9. The state Z1 then exists, indicating a piconetwork comprising the master terminal 6 and the slave terminals 7 and 8. By means of the signals INb and INc, the DPM software D1 informs the respective DPM software D2 and D3 about the connection termination. The respective DPM software D1, D2 and D3 then in turn transmits in each case a Leave Alert signal LE-AL to the respective UPnP controller software U1, U2 and U3. The DPM software D4 also informs its UPnP controller software U4 about the connection termination by means of the Disconnected signal DI-AL.

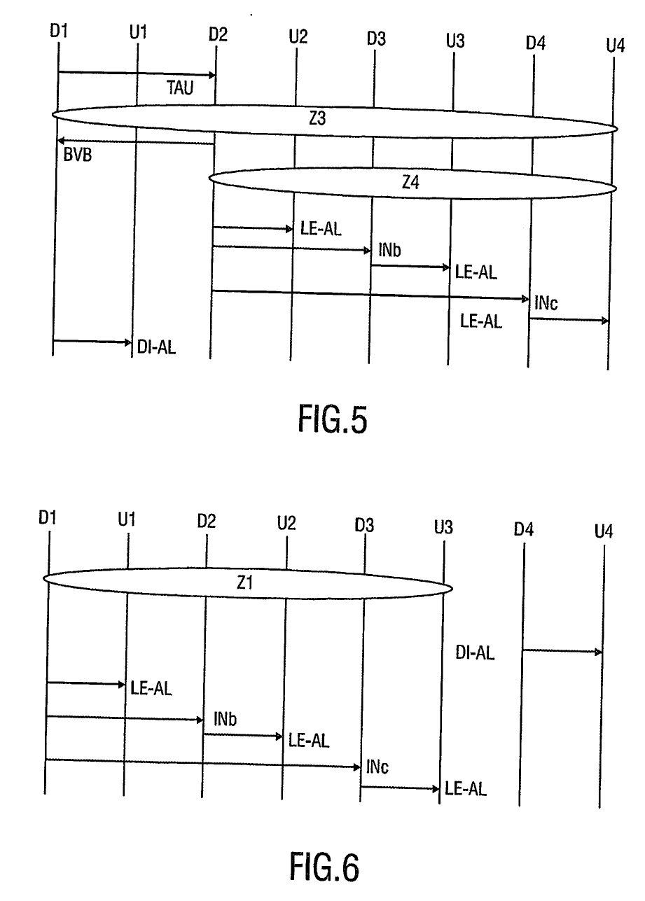

In the second case, the master terminal 6 wishes to leave the network, so that a slave terminal of the network has to take over the role of master terminal. The corresponding signal sequence in this respect is shown in FIG. 5. For this purpose, the master terminal 6 selects a slave terminal as new master terminal and carries out with the latter a master/slave role swap. In this case, the slave terminal 7 is defined as the new master terminal. The role swap is started with the signal TAU. Thereafter, a piconetwork exists which comprises the master terminal 7 and the slave terminals 6, 8 and 9 (state Z3). The connection termination procedure is then started in respect of the terminal 6. This proceeds in the same manner as described with respect to FIG. 4. Via the signal BVB, which is exchanged between the DPM software D2 and the DPM software D4, the master terminal 7 terminates the connection to the slave terminal 6. The state Z4 then exists, indicating a piconetwork comprising the master terminal 7 and the slave terminals 8 and 9. By means of the signals INb and INc, the DPM software D2 informs the respective DPM software D3 and D4 about the connection termination. The respective DPM software D2, D3 and D4 then in turn transmits in each case a Leave Alert signal LE-AL to the respective UPnP controller software U2, U3 and U4. The DPM software D1 also informs its UPnP controller software U1 about the connection termination by means of the Disconnected signal DI-AL.

The third case relates to the situation where a master terminal unexpectedly loses radio contact with a slave terminal. FIG. 6 shows the signal sequence for the case in which the master terminal 6 loses radio contact with the slave terminal 9. In this case, it is assumed that the slave terminal 9 has moved and is out of range of the network. No attempt is made to reintegrate the terminal 9 into the network; rather, the master terminal 6 informs its remaining slave terminals 7 and 8 about the loss of the terminal 9. A piconetwork remains which comprises the master terminal 6 and the slave terminals 7 and 8 (state Z1). Once it has been detected that radio contact has been lost, the DPM software D1 informs the respective DPM software D2 and D3, via the signals INb and INc, about the loss of the terminal 9. The respective DPM software D1, D2 and D3 then in turn transmits in each case a Leave Alert signal LE-AL to the respective UPnP controller software U1, U2 and U3. The DPM software D4 also informs its UPnP controller software U4 about the loss of the network by means of the Disconnected signal DI-AL.

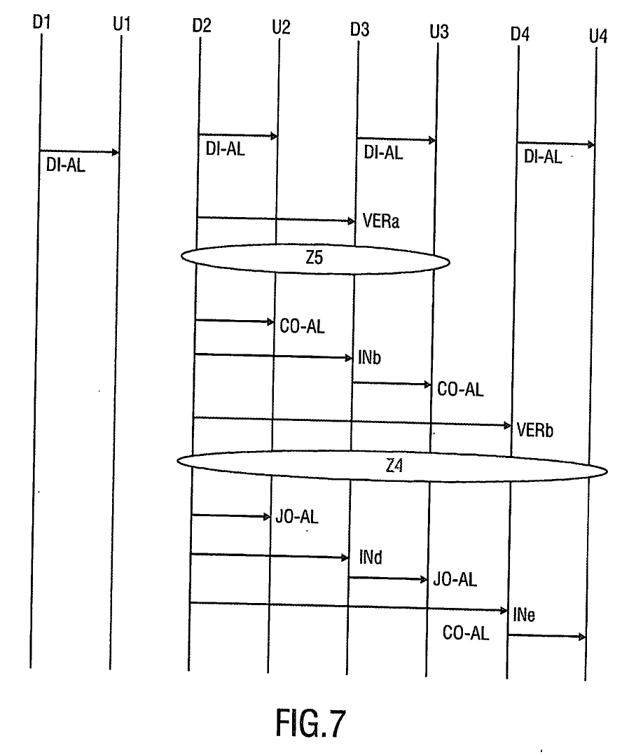

In the fourth case, a master terminal loses radio contact, without prior notice, with all slave terminals of the network This corresponds to the situation where the master terminal has moved and is now out of range of the other terminals. The master terminal does not then attempt to reestablish the connection to the other terminals. By contrast, the slave terminals attempt to reestablish the network without the master terminal. In order to do this, it must be defined which slave terminal is to take over the role of new master terminal. Since all terminals of the network know about the network topology, each of them knows the addresses of all other terminals. Each slave terminal therefore knows the addresses of the other slave terminals. The criterion used to select the new master terminal is the lowest address of the slave terminals. Therefore each slave terminal can itself check whether it should become the new master terminal or retain the role of a slave terminal as before. The corresponding signal sequence is shown in FIG. 7. In this case, it is assumed that the slave terminal 7 has the lowest address of all remaining slave terminals 7, 8 and 9. The terminal 7 therefore takes over the role of new master terminal and sets up successive connections to the other old slave terminals 8 and 9. The result is a reestablished network consisting of the new master terminal 7 and the slave terminals 8 and 9.

In FIG. 7, the respective DPM software D1 to D4 informs the respective UPnP controller software U1 to U4, after it has been detected that radio contact has been lost, about the loss of the respective connection by means of the Disconnected signals DI-AL. The respective DPM software D2 to D4 then checks whether it should assume the role of master terminal or slave terminal. Once the DPM software D2 has ascertained that it should take over the role of new master and the respective DPM software D3 and D4 has ascertained that it should retain its respective slave status, a connection is set up between new master terminal 7 and slave terminal 8 by means of the signal VERa between the DPM software D2 and the DPM software D3. Once the connection has been set up, the state Z5 exists with the piconetwork consisting of the terminals 7 and 8. By means of the signal INb, the DPM software D2 informs the DPM software D3 about the connection setup. The respective UPnP controller software U2 and U3 receives a Connected signal from the associated DPM software D2 and D3. Following transmission of the signal VERb from the DPM software D2 to the DPM software D4, the slave terminal 9 is integrated into the piconetwork so that, following successful connection setup, a network exists which comprises the terminals 7 to 9 (state Z4). Additionally, signals INd and INe are also transmitted from the DPM software D2 to the respective DPM software D3 and D4. The signal Join-Alert JO-AL is also exchanged between the respective DPM software D2 and D3 and the respectively associated UPnP controller software U2 and U3. The UPnP controller software U4 receives the Connected signal CO-AL from the DPM software D4.

The question arises as to how a terminal can recognize which of the four cases described above exists. In the first and second cases, the relevant terminals give prior notice of their wish to leave the network. This prior notice makes it easy for the master terminal to decide whether the first case (a slave terminal is leaving) or the second case (the master terminal itself is leaving) is concerned. In the third and fourth cases, only the master terminal can decide which case is concerned. If the master terminal loses the connection to all slave terminals, this is the fourth case. On the other hand, a slave terminal which loses the connection to its master terminal can only say with certainty whether it is out of range of the master terminal or whether the master terminal has moved. It is therefore assumed that each slave terminal, in the event of unexpected loss of radio contact with its master terminal, assumes that the master terminal itself has moved (i.e. the fourth case is concerned) and the remaining slave terminals attempt to reestablish the network.

The function of the DPM software 2 for this strategy can be explained with reference to the state diagram described in FIG. 8. When a terminal is a member of a piconetwork as a slave terminal, it is in the state Co-Sla indicated by block 10. The addresses of all other members of the network are known to the slave terminal. When the connection to the master terminal is terminated unexpectedly, the slave terminal passes into the state NR-Dis (rectangle 11) (arrow DI1). The slave terminal then attempts to reestablish the network. In the first step it ascertains whether it should assume the master or slave role in the network that is to be reestablished. For this, it checks whether it has the lowest address of all the former slave terminals. If it does have the lowest address, it takes over the master role in the network that is to be reestablished; if not, it assumes the slave role.

Hereinbelow, a description is given of the situation where the terminal takes over the master role. The situation where the terminal is to become the master terminal of the network that is to be reestablished is represented by the transition (arrow T1) to the state NR-P1 (rectangle 12). From the list comprising the addresses of the former slave terminals, it selects the first one and pages the associated terminal. If the paged terminal responds, both terminals are connected to one another and the paging terminal is master terminal of the piconetwork produced thereby. In FIG. 8 this corresponds to the transition (arrow PR1) to the state NR-C-M (rectangle 13). If the connection setup fails (i.e. the paged terminal does not respond) (arrow TO1), the terminal attempts to set up a connection to the former slave terminal that comes next in the list. If the connection setup is successful, it passes to the state NR-C-M (rectangle 13) (arrow PR1); if not, the process is attempted with the next terminal, and so on.

In the case where it has not been possible to set up a connection to any terminal contained in the list, the reestablishment of the network has failed and the terminal passes to the state Disc (rectangle 14) (arrow NRF). If it has been possible for the terminal to set up a connection to a terminal contained in the list, it is then in the state NR-C-M (rectangle 13) and attempts also to integrate the remaining former slave terminals into the new network. One terminal after another is paged in the order shown on the list. For each terminal that is to be integrated, the master terminal passes for this purpose to the state NR-P2 (rectangle 15) (arrow T3) and pages the corresponding terminal. If the paged terminal responds, then it has been successfully integrated into the network and the master terminal returns to the state NR-C-M (rectangle 13) (arrow PR2) and attempts to integrate the next terminal on the list into the network. On the other hand, if the paged terminal does not respond within a predefined time a change is likewise made to the state NR-C-M (rectangle 13) (arrow TO2) and an attempt is made to integrate the next terminal.

Once the master terminal has finished the list, it changes into the state Co-Mas (rectangle 16) (arrow T4). The network has been successfully reestablished. If the master terminal loses the connection to a slave terminal, it remains in the state Co-Mas (rectangle 16), as indicated by arrow DI2, provided that there is still at least one other slave terminal. Otherwise, i.e. if the last slave terminal has left, the master terminal changes to the state Disc (rectangle 14) (arrow DI3).

Hereinbelow, a description is given of the situation where the terminal takes over the slave role. The situation where the terminal is to assume the slave role of the network that is to be reestablished is represented by the transition (arrow T2) to the state NR-P-Sc (rectangle 17). In the state NR-P-Sc (rectangle 17), the terminal waits to be paged by the future master terminal. When it is paged, it responds thereto and changes to the state Co-Sla (rectangle 10) (arrow PA). If, on the other hand, it is not paged within a predefined time, it passes to the state Disc (rectangle 14) (arrow TO3).

The UPnP discovery phase in a terminal is initiated by the receipt of a Connected or Join Alert signal. Following integration of a new terminal (receipt of a Connected signal) into an existing network, its UPnP controller software triggers as server the transmission of a service message and as client the transmission of a service search message to the terminals of the network that were already integrated beforehand. These terminals then respond to these messages. If an already previously integrated terminal has not received a message from the new terminal after a predefined time (timeout), its UPnP controller software triggers the automatic sending of a service message or service search message to the newly integrated terminal.

If a new network comprising two terminals is to be set up, the UPnP controller software transmits, once it has received the Connected signal from the terminal with the lowest address, a service message or service search message to the other terminal. This other terminal with the higher address has accordingly waited on such a message. If the other terminal has not received a message from the terminal with the lower address after a predefined time (timeout), its UPnP controller software triggers the automatic sending of a service message or service search message to the terminal with the lower address.

When a terminal leaves the network, the respective DPM software ensures that all remaining terminals receive a Leave Alert signal. The UPnP controller software in terminal 6, which has left the network, receives from its DPM software a Disconnected signal. In such a case, the respective UPnP software can be instructed that all buffer-stored information in the terminals remaining in the network is to be deleted.

The function of the UPnP controller software can be explained with reference to the state diagram shown in FIG. 9. The UPnP controller software has a total of four states IU (Idle Unconnected), BE (Beaconing), WA (Waiting) and IMNW (Idle Member of Network), which are indicated by rectangles 18 to 21 in FIG. 9.

In the unconnected state, the UPnP controller software of a terminal is initially in the state IU (rectangle 18). In this state, the UPnP controller software configures the UPnP software such that it does not send out any periodic service messages (as server) or service search messages (as client).

As soon as the terminal has set up a connection to another terminal, the UPnP controller software of the terminal receives a Connected signal from the DPM software together with the address of the other terminal. Depending on whether its own address is lower or higher than that of the other terminal, the UPnP controller software of the terminal passes either to the state BE (rectangle 20) or to the state WA (rectangle 19).

If its own address is lower than that of the other terminal, the UPnP controller software passes to the state BE (rectangle 20) (arrow CO-LowAdr). In this state, the UPnP controller software triggers the sending of service messages if the terminal is a server or of service search messages if the terminal is a client. Thereafter, the UPnP controller software passes to the state IMNW (rectangle 21) (arrow BD).

If its own address is higher than that of the other terminal, the UPnP controller software passes to the state WA (rectangle 19) (arrow CO-HighAdr). In this state, the UPnP controller software waits on a service message or service search message from the other terminal. When a service search message or service message arrives, the terminal responds to this message in accordance with its role (client or server) and thereafter passes to the state IMNW (rectangle 21) (arrow RR).

If a service message or service search message from the other terminal does not arrive within a defined time interval (timeout), the UPnP controller software of the terminal passes from the state WA (rectangle 19) to the state BE (rectangle 20) (arrow ML) and triggers the sending of a service message (server) or service search message. Thereafter, the UPnP controller software passes to the state IMNW (rectangle 21) (arrow BD).

When a terminal in the state IU (rectangle 18) has been integrated into an existing network, the UPnP controller software receives from the associated DPM software a Connected signal together with the additional information that the connection to an existing network has taken place (and not to an individual terminal). In this case, the terminal passes to the state BE (rectangle 20) (arrow CO-NW) regardless of its address.

When another terminal has been integrated into the network of a terminal in the state IMNW (rectangle 21), the terminal receives a Join Alert signal and passes to the state Waiting (rectangle 19) (arrow JA).

When the UPnP controller software receives a Disconnected signal from the DPM software, it passes to the state IU (rectangle 18), regardless of which state it was in beforehand (arrow DISC).

When the UPnP controller software is in the state WA (rectangle 19) and is waiting on a service message or service search message from a specific terminal and in the meantime receives a Leave Alert signal relating to another terminal from the DPM software, it passes to the state IMNW (arrow LA-W).

When the UPnP controller software in the state IMNW (rectangle 21) receives a Leave Alert signal relating to a specific terminal, it instructs the UPnP software to delete all buffer-stored information about this terminal. The UPnP controller software remains in the state IMNW (rectangle 21), as indicated by arrow LA.

1. A wireless network comprising at least two terminals which each contain a UPnP (Universal Plug and Play) software component and a UPnP controller software component, wherein the UPnP controller software component of a terminal is provided to enable specific messages from the associated UPnP software component to subordinate software components only following a change in the network topology.

2. A wireless network as claimed in claim 1, characterized in that the UPnP controller software component of a terminal is provided to block messages from the associated UPnP software component prior to the setting up of a connection to the network.

3. A wireless network as claimed in claim 1, characterized in that the UPnP controller software component of a terminal is provided to block messages from the associated UPnP software component prior to the setting up of a connection of another terminal in the network.

4. A wireless network as claimed in claim 1, characterized in that the UPnP controller software component of a terminal is provided to transmit, after a connection has been set up to the only other terminal of the network, a search message relating to a specific service or a message about the availability of a specific service only if its own address meets a predefined criterion.

5. A wireless network as claimed in claim 4, characterized in that the UPnP controller software component of the terminal is provided to transmit a search message relating to a specific service or a message about the availability of a specific service if its own address is lower than the address of the other integrated terminal.

6. A wireless network as claimed in claim 4, characterized in that the UPnP controller software component of a further terminal is provided to transmit, after a connection has been set up, a search message relating to a specific service or a message about the availability of a specific service.

7. A wireless network as claimed in claim 4, characterized in that a terminal which after a defined time following the setting up of a connection to another terminal has not received its search message relating to a specific service or its message about the availability of a specific service is then provided to transmit its own search message relating to a specific service or its own message about the availability of a specific service.

8. A wireless network as claimed in claim 4, characterized in that the UPnP controller software component is provided to receive a Connected signal when the associated terminal is integrated, a Join Alert signal when another terminal is integrated, a Disconnected signal when the associated terminal leaves the network and a Leave Alert signal when the other terminal leaves, these signals being received from a DPM software component of the terminal which represents a subordinate software component and serves to detect changes in the network topology.

9. A wireless network as claimed in claim 4, characterized in that the UPnP controller software component of a terminal is provided to delete all information relating to another terminal after the other terminal has left the network, and in that the UPnP controller software component of the terminal which has left the network is provided to delete all information about the terminals still in the network.

10. A terminal in a wireless network comprising at least one other terminal, wherein the terminal contains a UPnP (Universal Plug and Play) software component and a UPnP controller software component, wherein the UPnP controller software component of the terminal is provided to forward specific messages from the associated UPnP software component to subordinate software components only following a change in the network topology.
